(19) United States
(12) Patent Application Publication
(10) Pub. No.: US 2015/0310519 A1
(43) Pub. Date: Oct. 29, 2015

(54) PRESCRIPTION EYEGLASS ORDERING THROUGH A USER DEVICE INTERFACE

(71) Applicants: Ron Gura, Tel Aviv (IL); Matanya Bar, Tel Aviv (IL); Erez Dickman, Tel Aviv (IL)

(72) Inventors: Ron Gura, Tel Aviv (IL); Matanya Bar, Tel Aviv (IL); Erez Dickman, Tel Aviv (IL)

(21) Appl. No.: 14/261,867

(22) Filed: Apr. 25, 2014

(51) Int. Cl. G06Q 30/06; G06F 19/00

(52) U.S. Cl. CPC G06Q 30/0621; G06Q 30/0635; G06F 19/3481

(57) ABSTRACT

There are provided systems and method for prescription eyeglass ordering through a user device interface. A user may input an eyeglass prescription to a server through taking a vision test using a user device application, inputting the specifics of the prescription through the application, or through taking an image of the prescription form. Once the prescription is input into the server, the server may present eyeglass frames to the user through information of the eyeglass frames. The information may include images of the eyeglass frames and may be superimposed on an image of the user to provide an approximate fit of the frames on the user. Additionally, measurements of the eyeglass frames and the user's head/facial features may be used in order to provide the fit. The user may choose to purchase the frame and may receive the frame having lenses matching the prescription.

### TECHNICAL FIELD

Example embodiments of the present application relate generally to prescription eyeglass ordering through a user device interface, and more specifically to providing a user device interface enabling a user to determine or input an eyeglass prescription and view eyeglass frames for ordering prescription eyeglasses.

### BACKGROUND

Vision care, including eyeglass prescriptions and eyeglass frame sales, constitute a large market globally, with approximately six out of ten people wearing eyeglasses. Traditionally, consumers visited optometrists or other vision care specialists, where they would receive a vision examination to determine the consumer's eyeglass prescription. Often the location where the consumer received their prescription further sold eyeglass frames and lens. However, the locations often would provide the eyeglass frames at a considerable markup or provide only a limited selection of available frame styles and brands. While more and more people utilize online sources to purchase eyeglass frames, the online market still makes up a relatively small portion of total vision care sales. Often, online purchases for wearable articles entail a certain degree of risk where the consumer is unable to determine whether the article would be a good fit and comfortable for the wearer. For articles such as eyeglasses that are required to be worn all day, every day, the degree of risk is off-putting to potential consumers. Additionally, some consumers cannot purchase lenses for the eyeglass frame online with the correct eyeglass prescription, and thus would be required to purchase the frames and still return to a physical location to have lenses installed.

### BRIEF DESCRIPTION OF THE DRAWINGS

FIG. 1 is a block diagram of a networked system suitable for implementing the process described herein, according to an embodiment;

FIG. 2A is an exemplary user device displaying an application interface for inputting an eyeglass prescription, according to an embodiment;

FIG. 2B is an exemplary user device displaying an application interface for viewing and selecting eyeglass frames, according to an embodiment;

FIG. 3 is a flowchart of an exemplary process for prescription eyeglass ordering through a user device interface, according to an embodiment; and

FIG. 4 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods that provide prescription eyeglass ordering through a user device interface. Systems suitable for practicing methods of the present disclosure are also provided.

In various embodiments, a user may utilize a user device to input an eyeglass prescription for the user. The user may utilize an application to perform an eye examination with the user device that determines the eyeglass prescription for the user. For example, the user may set the user device a specific distance away and attempt to read lines of text displayed to the user on the user device. In another embodiment, the user may utilize the user device to directly enter eyeglass prescription information into a form in the application that records the user's eyeglass prescription and transmits the information to a server. The form may include right and left eye spherical information, cylinder and axis information, and the amount to add to each eye. Moreover, in still other embodiments, the user may utilize the user device to capture an image of the eyeglass prescription that is uploaded to a server where either image analysis is performed on the image of the eyeglass prescription to determine the eyeglass prescription or an administrator, including potentially a vision care expert, reads the prescription and determines the user's eyeglass prescription.

Once the user's eyeglass prescription is uploaded and accessed by a server, the server may provide eyeglass frame information to the user. The eyeglass frame information may be provided to the user with user information so that the user may determine whether to purchase the eyeglass frame. Thus, the eyeglass frame information may include images of eyeglass frames that can be presented on an image of the user. The image of the user and the image of the eyeglass frame may be taken at a same set distance and with the same zoom aspect ratio so that the image of eyeglass frame is shown in a realistic size on the image of the user. Additionally, measurements may be taken of the eyeglass frame, such as height, width, eye frame width, nose bridge width and height, length of sides, etc. These measurements may be utilized with measurements of the user's head and/or face so that the eyeglass frames can be presented as they would fit the user. Weight, color, etc. nay also be provided to the user for the user to make an informed decision about purchasing the eyeglass frames.

Once the eyeglass frame information is communicated to the user device, the user may select one of the eyeglass frames for purchase. The server may complete the purchase, or may be utilized as an intermediary to purchase the eyeglass frame from a merchant selling the eyeglass frame. The server may also arrange for lenses matching the eyeglass frame to be created and installed into the eyeglass frame before shipping the eyeglass frame to the user.

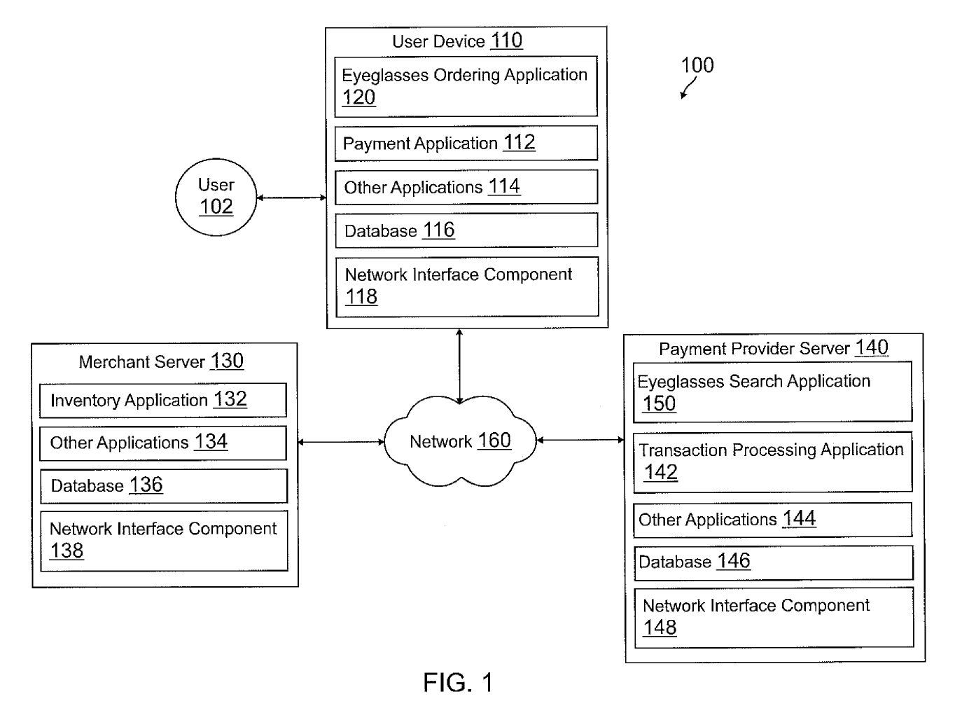

FIG. 1 is a block diagram of a networked system 100 suitable for implementing the process described herein according to an embodiment. As shown, system 100 may comprise or implement a plurality of devices, servers, and/or software components that operate to perform various methodologies in accordance with the described embodiments. Exemplary device and servers may include device, stand-alone, and enterprise-class servers, operating an OS such as a MICROSOFT® OS, a UNIX® OS, a LINUX® OS, or other suitable device and/or server based OS. It can be appreciated that the devices and/or servers illustrated in FIG. 1 may be deployed in other ways and that the operations performed and/or the services provided by such devices and/or servers may be combined or separated for a given embodiment and may be performed by a greater number or fewer number of devices and/or servers. One or more devices and/or servers may be operated and/or maintained by the same or different entities.

System 100 includes a user 102, a user device 110, a merchant server 130, and a payment provider server 140 in communication over a network 160. User 102 may utilize user device 110 to input an eyeglasses prescription to payment provider server 140. User 102 may also receive eyeglasses frame information using user device 110. The eyeglasses frame information may correspond to available eyeglasses frames from merchant server 130. Once user 102 selects an eyeglasses frame for purchase, payment provider server 140 may be utilized to complete the purchase and arrange for prescription lenses matching the eyeglasses prescription to be installed into the eyeglasses frame.

User device 110, merchant server 130, and payment provider server 140 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 160.

User device 110 may be implemented using any appropriate hardware and software configured for wired and/or wireless communication with merchant server 130 and/or payment provider server 140. For example, in one embodiment, user device 110 may be implemented as a personal computer (PC), a smart phone, laptop computer, wristwatch with appropriate computer hardware resources, eyeglasses with appropriate computer hardware (e.g. GOOGLE GLASS®) and/or other types of computing devices capable of transmitting and/or receiving data, such as an IPAD® from APPLE®. Although a user device is shown, the user device may be managed or controlled by any suitable processing device. Although only one user device is shown, a plurality of user devices may operate similarly.

User device 110 of FIG. 1 contains an eyeglass ordering application 120, a payment application 112, other applications 114, a database 116, and a network interface component 118. Food search application 120, payment application 112 and other applications 114 may correspond to processes, procedures, and/or applications executable by a hardware processor, for example, a software program. In other embodiments, user device 110 may include additional or different software as required.

Eyeglass ordering application 120 may correspond to an application that enables user 102 to enter eyeglass prescription information and browse eyeglass frames for purchase. Thus, eyeglass ordering application 120 may provide an interface enabling user 102 to enter information to payment provider server 140 and view information from merchant server 130 and/or payment provider server 140. In this regard, eyeglass ordering application 120 may include an application interface enabling user 102 to enter eyeglass prescription information or provide information for payment provider server 140 to determine the eyeglass prescription. An eyeglass prescription may correspond to a document for an eyeglass wearer, user 102, that determines the values and strengths of a prescription eyeglass lens to correct the vision of user 102. An eyeglass prescription may be for reading lenses and only provide a magnification. However, in other embodiments, the parameters of the eyeglass prescription may cover near and/or far sightedness (e.g., myopia and/or hyperopia), astigmatism, or other vision impairments. The eyeglass prescription may account of bifocal and/or trifocal lenses, UV protection, tint, or other necessary corrections.

User 102 may utilize eyeglass ordering application 120 to take an eye examination to determine the eyeglass prescription. For example, eyeglass ordering application 120 may present instructions to user 102 with lines of text and ask user 102 to read, record, or speak the lines of text. The instructions may include how far user 102 should stand from user device 110, where user 102 should place user device 110, and what eye to cover while reading the lines of text. The lines of text may include letters with sizes similar to an eye exam chart in an optometrist's or doctor's office. If user 102 reads the lines of text out loud, eyeglass ordering application 120 may receive the lines of texts and interpret them to determine whether user 102 is correctly reading the lines of text. In other embodiments, user 102 may input responses to user device 110 that are checked against the lines of text.

In other embodiments where it is important to determine other eyeglass prescription information, such as distance and near vision, right/left spherical, cylindrical, and axis information, and/or other prescription information, user 102 may utilize a form interface in eyeglass ordering application 120 to enter the information. If a prescription is required to be verified, or user 102 prefers, user 102 may utilize a camera application or eyeglass ordering application 120 to capture an image of the eyeglass prescription and upload the image to payment provider server 140. Thus, payment provider server 140 may determine the eyeglass prescription from the image, as will be explained in more detail herein.

Eyeglass ordering application 120 may further be utilized to provide an interface where user 102 can browse and select eyeglass frames for purchase. An eyeglass frame may correspond to the structural component of eyeglasses that account for holding the lenses in place and positioning the eyeglass frame on the face of user 102. Thus, eyeglass frames may correspond to a wide variety of styles, brands, colors, and/or materials that are purchasable to hold lenses in place. User device 110 may receive information about merchant server 130 from payment provider server 140, including eyeglass frame information. Eyeglass frame information may include images of eyeglass frames, as well as eyeglass frame measurements, materials, brands, colors, prices, shipping and delivery information, etc. Utilizing eyeglass frame information with user information, eyeglass ordering application 120 may present the eyeglass frame with sufficient information enabling user 102 to determine if the eyeglass frames would meet user 102's requirements. User 102 may also utilize eyeglass ordering application 120 to input preferences for eyeglass frames, such as weight, material, color, brand, etc. Thus, eyeglass ordering application 120 may present eyeglass frame information corresponding to personalized preferences of user 102.

Eyeglass ordering application 120 may present an image of an eyeglass frame superimposed onto an image of user 102. Thus, user 102 is able to see what the eyeglass frame would look like on user 102. In order to present the image properly and to a correct size on user 102, an image of user 102 may be taken at a specific distance corresponding to the distance from which the image of the eyeglass frame was taken. Additionally, a zoom factor may be required to be the same so that the measurements and aspect ratio line up. In various embodiments, eyeglass ordering application 120 may request measurements of user 102's head and/or face, including facial features, so that the eyeglass frame's measurements may be compared. The measurements of user 102 and the eyeglass frame may also be used to line up and arrange the eyeglass frame image on the image of user 102. Additionally, eyeglass ordering application 120 may present the measurements, such as weight, height, length, etc., to user 102 so that user 102 may determine whether the eyeglass frame is likely to fit.

If user 102 chooses to purchase an eyeglass frame, payment application 112 may be utilized with eyeglass frame application 120 to complete the purchase order for the eyeglasses, include the eyeglass frame and lenses matching the eyeglass prescription. Payment application 112 may be used, for example, to provide a convenient interface to permit user 102 to select payment options and provide payment for the eyeglasses. Payment application 112 may be implemented as an application having a user interface enabling the user to enter payment options for storage by user device 110, provide payment on checkout of an item (e.g., eyeglass frames, lenses, and/or other eyeglass goods) with merchant server 130 and/or payment provider server 140, and complete a transaction for the item with merchant server 130 and/or payment provider server 140. In certain embodiments, payment application 112 may correspond more generally to a web browser configured to view information available over the Internet or access a website corresponding to a payment provider.

Payment application 112 may utilize user financial information, such as a credit card, bank account, or other financial account to complete payment. Additionally, payment application 112 may provide payment for eyeglasses using a user account with the payment provider, such as payment provider server 140. Payment application 112 may include cross-linking, allowing user 102 to identify a user account through an identifier for a separate user account (e.g. identifying a user account through a debit card account number and vice versa). Payment application 112 may further include options to store transaction histories for purchased eyeglasses, such as receipts, for later use, including redemption of the purchased item at a physical merchant location. Thus, payment application 112 provides an interface enabling user 102 to provide proof of purchase of an item to a merchant. Payment application 112 may further be utilized to provide shipping options for the delivery of the purchased eyeglasses. Once a transaction for the eyeglasses is completed, merchant server 130 and/or payment provider server 140 may complete the eyeglasses and deliver them to user 102.

User device 110 includes other applications 114 as may be desired in particular embodiments to provide features to user device 110. For example, other applications 114 may include security applications for implementing client-side security features, programmatic client applications for interfacing with appropriate application programming interfaces (APIs) over network 160, or other types of applications. Other applications 114 may also include email, texting, voice and IM applications that allow a user to send and receive emails, calls, texts, and other notifications through network 160. In various embodiments, other applications 114 may include financial applications, such as banking, online payments, money transfer, or other applications associated with payment provider server 140. Additionally, other application may include browser applications, social media applications, camera applications, and/or mapping/check-in applications. Other applications 114 may contain other software programs, executable by a processor, including a graphical user interface (GUI) configured to provide an interface to the user.

User device 110 may further include database 116 which may include, for example, identifiers such as operating system registry entries, cookies associated with eyeglass ordering application 120, payment application 112, and/or other applications 114, identifiers associated with hardware of user device 110, or other appropriate identifiers, such as identifiers used for payment/user/device authentication or identification. In one embodiment, identifiers in database 116 may be used by user device 110, merchant server 130, and/or payment provider server 140, to associate user device 110 with a particular account maintained by payment provider server 140. Database may include information utilized by eyeglass ordering application 120 including eyeglass prescription information, eyeglass frame information (e.g., eyeglass frame measurements, images, colors/materials, etc.), and/or user information (e.g., user images, head/facial measurements, etc.). Database 116 may include transaction histories usable to present proof of purchase of eyeglasses, including eyeglass frames, lenses, or a combination of both, to merchant server 130, a merchant location corresponding to merchant server 130, and/or payment provider server 140.

Database 116 may include information used by payment application 112, for example, user personal information (e.g. a name, social security number, user financial information, or other identifying information), a user account identifier (e.g. user account identifier is at least one of a user identifier, a user credit or debit card number, a user account name, and a user account number), and/or a user device identifier. In various embodiments, database 116 may include online account access information.

In various embodiments, user device 110 includes at least one network interface component 118 adapted to communicate with merchant server 130 and/or payment provider server 140. Network interface component 118 may include a DSL (e.g., Digital Subscriber Line) modem, a PSTN (Public Switched Telephone Network) modem, an Ethernet device, a broadband device, a satellite device and/or various other types of wired and/or wireless network communication devices.

Merchant server 130 may correspond, for example, to a merchant or seller offering eyeglasses, including eyeglass frames and/or prescription lenses, for sale to user 102. Generally, merchant server 130 may be maintained by anyone or any entity that receives money in exchange for vision care, which may including online marketplaces, vision care chains, independent stores (including optometrist stores), eyeglass providers (e.g., eyeglass brands), etc. In this regard, merchant server 130 may include processing applications, which may be configured to interact with user device 110 and/or payment provider server 140 to facilitate the sale of eyeglasses and related items to user 102. Merchant server 130 may correspond to a networked server for a plurality of merchant locations or for an online marketplace. Although only one merchant server is shown, a plurality of different merchants and merchant servers may operate similarly.

Merchant server 130 includes an inventory application 132, other applications 134, a database 136, and a network interface component 138. Inventory application 132 and other applications 134 may correspond to processes, procedures, and/or applications executable by a hardware processor, for example, a software program. In other embodiments, payment provider server 140 may include additional or different software as required.

Inventory application 132 may be configured to provide eyeglass information to user 102, offer eyeglasses for sale to user 102, and complete a transaction for eyeglasses with user device 110 and/or payment provider server 140. In this regard, inventory application 132 may access and provide an inventory of eyeglass frames and available lenses to user 102 through user device 110. Inventory application 132 may receive a request to view eyeglass frame information for one or more eyeglass frames from user device 110 and/or payment provider server 140 and may provide the eyeglass frame information to user device 110 and/or payment provider server 140. The eyeglass frame information may include eyeglass frame images, which, as previously discussed, may be taken with a specific distance, zoom, and/or aspect ratio. Additionally, the eyeglass frame information may further include eyeglass frame specifications, such as measurements, weight, color, material, etc. The eyeglass frame information may further include price, sales/discount opportunity, or other financial information.

In addition to eyeglass frame information for one or more eyeglass frames, inventory application 132 may provide, to user device 110 and/or payment provider server 140, information about prescription eyeglass lenses offered by merchant server 130 and used with the eyeglass frames. The lens information may include offered prescriptions (e.g., whether merchant server 130 can construct and/or dispense the corrective lenses to fix the ocular impairment of user 102), materials, weights, prices etc. Information included about lenses may allow user 102 to determine if merchant server 130 can provide correct eyeglasses to user 102.

In various embodiments, merchant server 130 includes other applications 134 as may be desired in particular embodiments to provide features to merchant server 130. For example, other applications 134 may include security applications for implementing device/server-side security features, programmatic server applications for interfacing with appropriate application programming interfaces (APIs) over network 160, or other types of applications. Other applications 134 may contain software programs, executable by a processor, including a graphical user interface (GUI), configured to provide an interface to a user. In various embodiments, other applications 134 may include payment applications configured to interact with user device 110 and/or payment provider server 140 to complete payment for eyeglasses.

Additionally, merchant server 130 includes database 136. Database 136 may include merchant inventory and/or location information. For example, database 136 may include information about available eyeglass frames and lenses for those frames. Additionally, database 136 may include information about merchant locations where user 102 may pick up eyeglasses after purchase. In other embodiments, database 136 may include shipping information for available shipping of eyeglasses to user 102 and shipping information for user 102 (e.g., a physical address). After completing payment for eyeglasses, database 136 may include transaction history information. Database 136 may store other information relevant to user 102, such as eyeglass prescription information, optometrist and/or doctor information, etc.

In various embodiments, merchant server 130 includes at least one network interface component (NIC) 138 adapted to communicate with network 160 including user device 110 and/or payment provider server 140. In various embodiments, network interface component 138 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Payment provider server 140 may be maintained, for example, by an online payment service provider, which may provide eyeglasses searching/ordering and payment services to user 102. In this regard, payment provider server 140 includes one or more processing applications, which may receive eyeglasses prescription information, provide eyeglasses information to user 102, and complete payment for items between user device 110 and merchant server 130. In one example, payment provider server 140 may be provided by PAYPAL®, Inc. of San Jose, Calif., USA. However, in other embodiments, payment provider server 140 may be maintained by or include a merchant, financial services provider, and/or other service provider, which may provide user account and payment service to user 102. For example, eyeglasses search and purchase features may be provided by EBAY®, Inc. of San Jose, Calif., USA. Although payment provider server 140 is described as separate from a merchant and/or merchant server corresponding to merchant server 130, it is understood that a merchant may include services offered by payment provider server 140.

Payment provider server 140 of FIG. 1 includes an eyeglass search application 150, a transaction processing application 142, other applications 144, a database 146, and a network interface component 148. Eyeglass search application 150, transaction processing application 142, and other applications 144 may correspond to processes, procedures, and/or applications executable by a hardware processor, for example, a software program. In other embodiments, payment provider server 140 may include additional or different software as required.

Eyeglass search application 150 may correspond to an application configured to receive a request from user device 110 to search for eyeglasses for user 102 and provide eyeglass information to user device 110 for presentation with user information of user 102. In this regard, eyeglass search application 150 may receive an eyeglass prescription or information to determine an eyeglass prescription from user device 110, as previously discussed. Eyeglass search application 150 may store the eyeglass prescription, such as in database 146, or may transmit the eyeglass prescription to merchant server 130 for use in constructing corrective lenses for use in an eyeglass frame for user 102.

Additionally, eyeglass search application 150 may further provide eyeglass frame information for one or more eyeglass frames to user device 110 for presentation to user 102 with user information. Thus, eyeglass search application 150 may retrieve eyeglass frame information from merchant server 130 or other merchant offering eyeglass frames for sale. Eyeglasses search application 150 may retrieve all available eyeglass frame information from the sources, or may limit search and retrieval of eyeglass frame information to those eyeglass frames that match the preferences of user 102, as previously discussed. Eyeglass frame information provided to user device 110 may include images, measurements, and/or other specifications of the eyeglass frame. If user 102 selects an eyeglass frame and transmits a purchase request for the eyeglass frame (and, in various embodiments, the lenses for use in the eyeglass frame), eyeglass search application 150 may provide information to complete the purchase request with user device 110 and the merchant server 130. Payment requests may be completed and transaction histories provided using transaction processing application 142, as will be explained in more detail herein. If required, eyeglass search application 150 may provide merchant server 130 or another merchant with user information to complete ordering of the glasses, such as user information including eyeglass prescription information, as previously discussed.

Transaction processing application 142 may be configured to receive information from user device 110 and/or merchant server 130 for processing and completion of financial transactions. Transaction processing application 142 may include one or more applications to process financial transaction information from user device 110 and/or merchant server 130. Transaction processing application 142 may receive a payment request to complete a sale transaction for an item, such as eyeglass frames and/or lenses matching an eyeglass prescription. Transaction processing application 142 may complete the sale transaction by providing payment to merchant server 130. Transaction processing application 142 may receive a user payment account for user 102 with payment provider server 140 to provide payment to merchant server 130. In other embodiments, transaction processing application 142 may receive user financial information, such as a payment card, bank account, gift card, or other financial information. Transaction processing application 142 may credit the payment to a payment account of merchant server 130 with payment provider server 140 or to another financial account, such as a bank account. In other embodiments, transaction processing application 142 may provide transaction histories, including receipts, to user device 110 and/or merchant server 130 in order to provide proof or purchase and complete the financial transaction.

In various embodiments, payment provider server 140 includes other applications 144 as may be desired in particular embodiments to provide features to payment provider server 140. For example, other applications 144 may include security applications for implementing server-side security features, programmatic server applications for interfacing with appropriate application programming interfaces (APIs) over network 160, or other types of applications. Other applications 144 may contain software programs, executable by a processor, including a graphical user interface (GUI), configured to provide an interface to a user.

Additionally, payment provider server 140 includes database 146. As previously discussed, user 102 and/or merchant server 130 may establish one or more user accounts with payment provider server 140. User accounts in database 146 may include user/merchant information, such as name, address, birthdate, payment/funding information, additional user financial information, and/or other desired user data. User 102 and merchant server 130 may link user accounts to user device 110 through a user, merchant, and/or device identifier. Thus, when an identifier is transmitted to payment provider server 140, e.g. from user device 110 and/or merchant server 130, a user account belonging to user 102 and/or merchant server 130 may be found. In other embodiments, user 102 and/or merchant server 130 may not have previously established a user account and may provide other financial information to payment provider server 140 to complete financial transactions, as previously discussed.

In various embodiments, payment provider server 140 includes at least one network interface component (NIC) 148 adapted to communicate with network 160 including user device 110 and/or merchant server 130. In various embodiments, network interface component 148 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 160 may be implemented as a single network or a combination of multiple networks. For example, in various embodiments, network 160 may include the Internet or one or more intranets, landline networks, wireless networks, and/or other appropriate types of networks. Thus, network 160 may correspond to small scale communication networks, such as a private or local area network, or a larger scale network, such as a wide area network or the Internet, accessible by the various components of system 100.

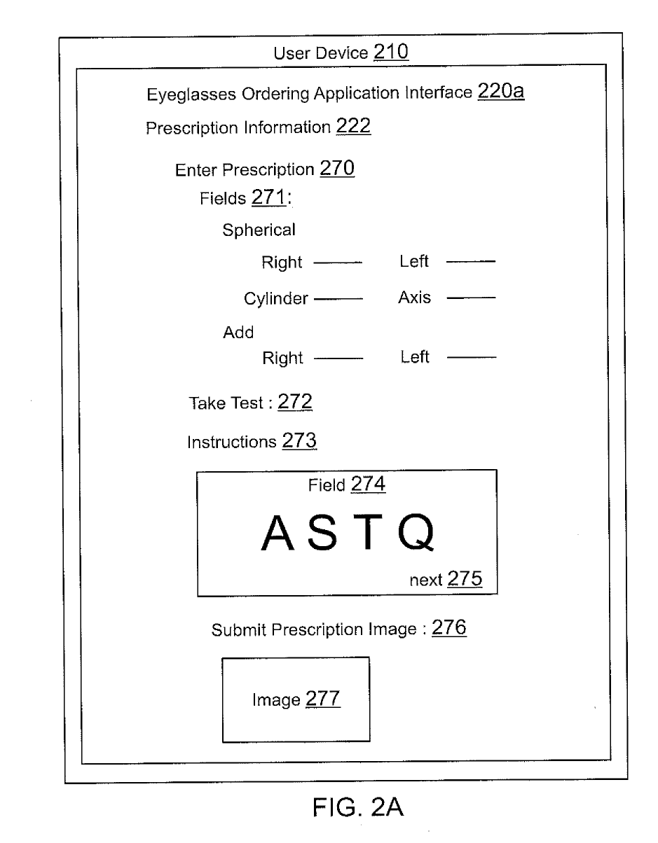

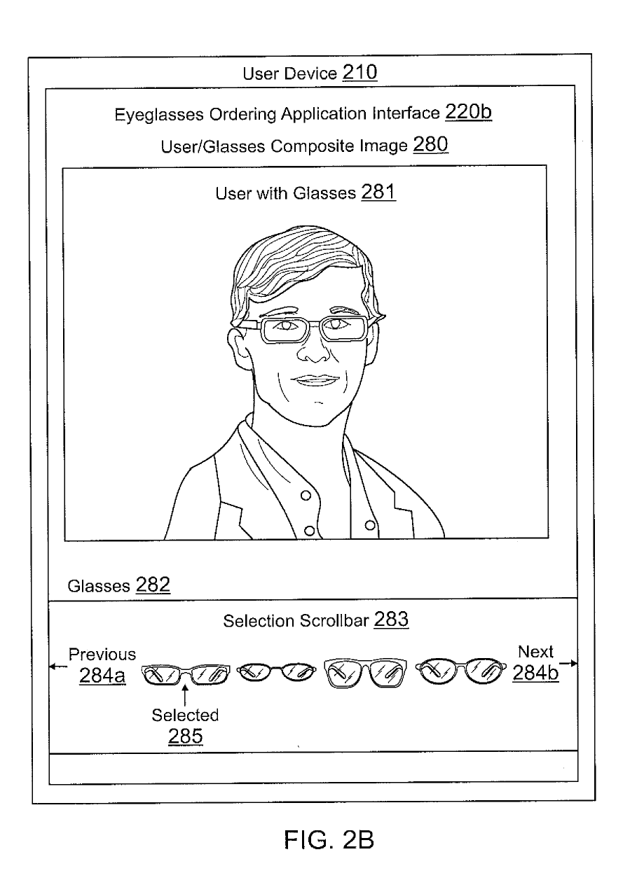

FIG. 2A is an exemplary user device displaying an application interface for inputting an eyeglass prescription, according to an embodiment. FIG. 2A includes a user device 210 displaying an eyeglass ordering application interface 220a corresponding generally to user device 110 and eyeglass ordering application 120, respectively, of FIG. 1.

A user (not shown) may utilize user device 210 to enter eyeglass prescription information using eyeglass ordering application interface 220a. Thus, eyeglass ordering application interface 220a displays fields under prescription information 222 for entering eyeglass prescription information, an enter prescription 270 field, a take test 272 field, and a submit prescription image 276 field. Although three fields are shown in FIG. 2A, other embodiments may include different or additional fields as required.

In enter prescription 270 field, the user may manually enter a prescription. Thus, enter prescription 270 field includes fields 271 having prescription information (e.g., right/left spherical, cylinder, axis, and add information, as would be found on an eyeglass prescription document). The user may utilize a touch screen, attached input device, voice inputs, or other mechanism to input information to each of the fields. Once the information is input, the user may submit the prescription information to a server for analysis. If necessary, the server and/or user device 210 may request optometrist/doctor information for the user in order to verify the prescription.

In take test 272 field, a user may take an eye/vision examination that determines prescription information. Thus, instructions 273 may include instructions for the user to utilize with field 274. The instruction may include a distance from which the user must view the user device/field 274. Additionally, the instruction may correspond to the type of input for take test 272 field, such as text input and/or voice input. The input by the user may be matched against the information in field 274 to determine an approximate required corrective lens to provide to the user. Once the user has completed field 274, the user may advance to the next field or submit the eye/vision examination using next 275 button. While the test under take test 272 may not measure other potential requirements for a prescription, such as astigmatism, etc., the test may be utilized to provide reading frames or may be utilized in conjunction with other input, such as a previous or additional eyeglasses prescription from an optometrist/doctor.

Under submit prescription image 276 field, a user may submit an image of an eyeglass prescription document for use by a server in determining the user's eyeglass prescription. Thus, image 277 may include an image taken by a camera, such as a camera of mobile device 210, of a physical eyeglass prescription document. Image 277 may be submitted to a server, where character recognition software and/or an administrator (e.g., a person reviewing eyeglasses prescription documentation) may determine the eyeglass prescription.

FIG. 2B is an exemplary user device displaying an application interface for viewing and selecting eyeglass frames, according to an embodiment. FIG. 2B includes a user device 210 displaying an eyeglass ordering application interface 220b corresponding generally to user device 110 and eyeglass ordering application 120, respectively, of FIG. 1.

A user may further utilize user device 210 to view, select, and purchase eyeglass frames for use with prescription eyeglass lenses matching the eyeglass prescription entered in FIG. 2A. Thus, eyeglass ordering application interface 220b includes a user/glasses composite image 280 and glasses 282. User/glasses composite image 280 displays a user with glasses 281 image that include a composite of eyeglass frame information (e.g., an eyeglass frame image) and user information (e.g., an image of the user). In various embodiments, certain image information, measurements, etc., may be utilized to properly present the eyeglass frame information with the user information. For example, an image of an eyeglass frame may be taken at a certain distance, with a certain zoom, and having a certain aspect ratio to properly define the size of the eyeglass frame. Similarly, an image of the user may also be taken with the same or similar measurements. Thus, when the image of the eyeglass frame is superimposed on the image of the user to generate a composite image, the eyeglasses may be properly presented as they would fit the user. In certain embodiments, measurements of the eyeglass frames may be taken, such as height, length, width, weight, etc., as well as measurements of the aspects of the eyeglass frame, such as bridge width, individual lens frame height/width, etc. The measurements may be presented to the user. Additionally, the measurements may be utilized with user head and/or facial feature measurements to determine a proper fit for the eyeglass frame and/or present the an image of the eyeglass frame on an image of the user as they would fit the user.

Under glasses 282, the user may select eyeglass frames for viewing under user/glasses composite image 281. Thus, in selection scrollbar 283, the user is presented with a variety of eyeglass frame images. The eyeglass frames presented in selection scrollbar 283 may correspond to all eyeglasses available from search merchants or may match preferences of the user for size, shape, color, material, price, brand, etc. In FIG. 2B, the user has chosen the eyeglass frame denoted selected 285, which is presented in user/glasses composite image 280. As the user browses through glasses 282 using previous 284a button and next 284b button, and moves selected 285 to a new eyeglass frame, the eyeglass frame presented in user/glasses composite image 280 may change to present the new selected frame on the image of the user.

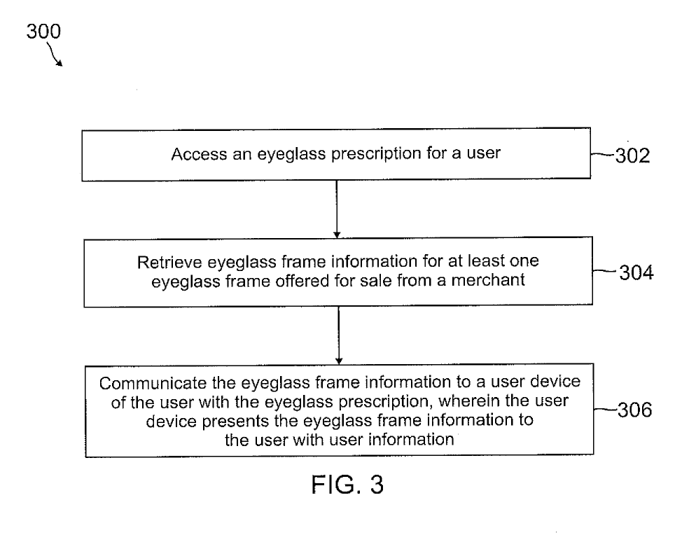

FIG. 3 is a flowchart of an exemplary process for prescription eyeglass ordering through a user device interface, according to an embodiment. Note that one or more steps, processes, and methods described herein may be omitted, performed in a different sequence, or combined as desired or appropriate.

At step 302, the eyeglass prescription for the user is accessed. A user device may perform an eye examination with the user to determine the eyeglass prescription. In other embodiments, a user may enter the eyeglass prescription to the user device. Thus, the eyeglass prescription may be received from the user device. In still other embodiments, the user may capture an image of a document containing the eyeglass prescription, which may be transmitted by the user device. Thus, the eyeglass prescription may be determined from the image.

Eyeglass frame information for at least one eyeglasses frame offered for sale from a merchant may be received, at step 304. The eyeglass frame information may comprise at least one eyeglass frame image of the at least one eyeglass frame. Additionally, the eyeglass frame information may comprise at least one eyeglass frame measurement for the at least one eyeglass frame.

At step 306, the eyeglass frame information may be communicated to a user device of the user with the eyeglass prescription, wherein the user device presents the eyeglass frame information to the user with user information. The user information may comprise a user image of the user, wherein the user device presents the at least one eyeglass frame image on the user image to the user. In various embodiments, the at least one eyeglass frame image and the user image may be captured at the same distance and comprise the same aspect ratio. Additionally, the user information may further comprises user head and/or facial measurements, wherein the user device further correlates the at least one eyeglass frame measurements to the user head and/or facial measurements when presenting the at least one eyeglass frame image on the user image to the user. In other embodiments, the user device may correlate the at least one eyeglass frame measurements to the user head and facial measurements to present a fit of the at least one eyeglass frame on the user to the user.

In various embodiments, a purchase request is received for one of the at least one eyeglass frame. The purchase request may be completed with the merchant for the one of the at least one eyeglass frame. Additionally, the purchase request may further be completed with the merchant for a lens in the one of the at least one eyeglass frame matching the eyeglass prescription.

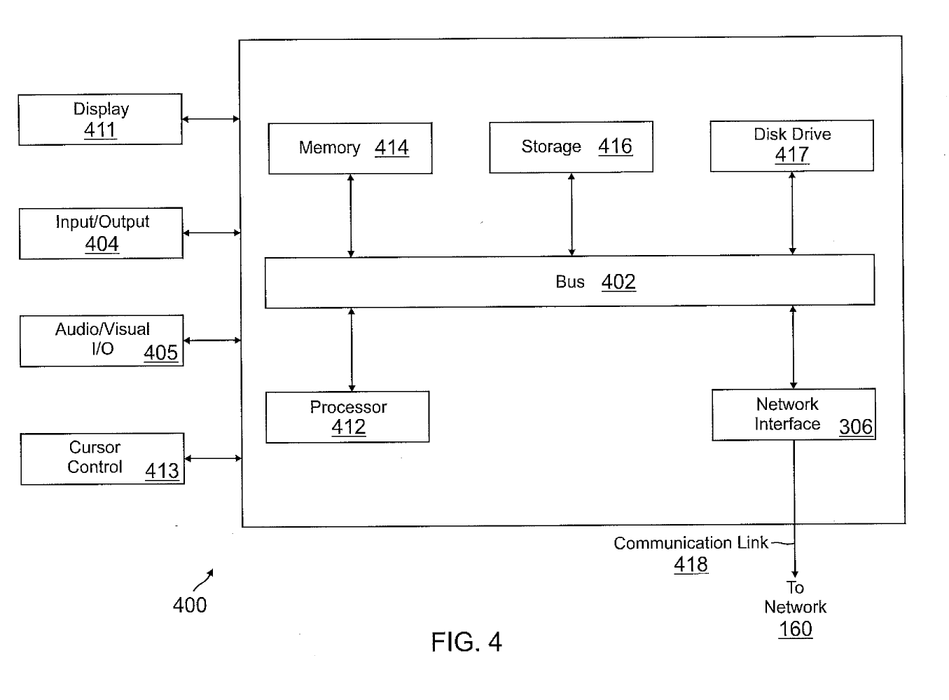

FIG. 4 is a block diagram of a computer system suitable for implementing one or more components in FIG. 1, according to an embodiment. In various embodiments, the user device may comprise a personal computing device (e.g., smart phone, a computing tablet, a personal computer, laptop, Bluetooth device, key FOB, badge, a wearable computing device, etc.) capable of communicating with the network. The merchant server and/or service provider may utilize a network computing device (e.g., a network server) capable of communicating with the network. It should be appreciated that each of the devices utilized by users and service providers may be implemented as computer system 400 in a manner as follows.

Computer system 400 includes a bus 402 or other communication mechanism for communicating information data, signals, and information between various components of computer system 400. Components include an input/output (I/O) component 404 that processes a user action, such as selecting keys from a keypad/keyboard, selecting one or more buttons, image, or links, and/or moving one or more images, etc., and sends a corresponding signal to bus 402. I/O component 404 may also include an output component, such as a display 411 and a cursor control 413 (such as a keyboard, keypad, mouse, etc.). An optional audio input/output component 405 may also be included to allow a user to use voice for inputting information by converting audio signals. Audio I/O component 405 may allow the user to hear audio. A transceiver or network interface 406 transmits and receives signals between computer system 400 and other devices, such as another user device, a merchant server, or a service provider server via network 160. In one embodiment, the transmission is wireless, although other transmission mediums and methods may also be suitable. One or more processors 412, which can be a micro-controller, digital signal processor (DSP), or other processing component, processes these various signals, such as for display on computer system 400 or transmission to other devices via a communication link 418. Processor(s) 412 may also control transmission of information, such as cookies or IP addresses, to other devices.

Components of computer system 400 also include a system memory component 414 (e.g., RAM), a static storage component 416 (e.g., ROM), and/or a disk drive 417. Computer system 400 performs specific operations by processor(s) 412 and other components by executing one or more sequences of instructions contained in system memory component 414. Logic may be encoded in a computer readable medium, which may refer to any medium that participates in providing instructions to processor(s) 412 for execution. Such a medium may take many forms, including but not limited to, non-volatile media, volatile media, and transmission media. In various embodiments, non-volatile media includes optical or magnetic disks, volatile media includes dynamic memory, such as system memory component 414, and transmission media includes coaxial cables, copper wire, and fiber optics, including wires that comprise bus 402. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 400. In various other embodiments of the present disclosure, a plurality of computer systems 400 coupled by communication link 418 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a non-transitory memory storing user information comprising an eyeglass prescription for a user; and
one or more hardware processors in communication with the non-transitory memory and configured to:
access the eyeglasses prescription for the user;
retrieve eyeglass frame information for at least one eyeglass frame offered for sale from a merchant; and
communicate the eyeglass frame information to a user device of the user with the eyeglass prescription, wherein the user device presents the eyeglass frame information to the user with user information.

2. The system of claim 1, wherein the eyeglass frame information comprises at least one eyeglass frame image of the at least one eyeglass frame, wherein the user information comprises a user image of the user, and wherein the user device presents the at least one eyeglass frame image on the user image to the user.

3. The system of claim 2, wherein the at least one eyeglass frame image and the user image are captured at the same distance and comprise the same aspect ratio.

4. The system of claim 2, wherein the eyeglass frame information further comprises at least one eyeglass frame measurement for the at least one eyeglass frame, and wherein the user information further comprises user head and facial measurements, and wherein the user device further correlates the at least one eyeglass frame measurements to the user head and facial measurements when presenting the at least one eyeglass frame image on the user image to the user.

5. The system of claim 1, wherein the eyeglass frame information comprises at least one eyeglass frame measurements for the at least one eyeglass frame, and wherein the user information comprises user head and facial measurements, and wherein the user device further correlates the at least one eyeglass frame measurements to the user head and facial measurements to present a fit of the at least one eyeglass frame on the user to the user.

6. The system of claim 1, wherein the user device performs an eye examination with the user to determine the eyeglasses prescription, and wherein the one or more hardware processors are further configured to:
receive the eyeglass prescription from the user device.

7. The system of claim 1, wherein the user captures an image of a document containing the eyeglass prescription using the user device, and wherein the one or more hardware processors are further configured to:
receive the image from the user device; and
determine the eyeglass prescription from the image.

8. The system of claim 1, wherein the user enters the eyeglasses prescription to the user device, and wherein the one or more hardware processors are further configured to:
receive the eyeglass prescription from the user device.

9. A method comprising:
accessing an eyeglass prescription for a user;
retrieving eyeglass frame information for at least one eyeglass frame offered for sale from a merchant; and
communicating, using one or more hardware processors, the eyeglass frame information to a user device of the user with the eyeglass prescription, wherein the user device presents the eyeglass frame information to the user with user information.

10. The method of claim 9, wherein the eyeglass frame information comprises at least one eyeglass frame image of the at least one eyeglass frame, wherein the user information comprises a user image of the user, and wherein the user device presents the at least one eyeglass frame image on the user image to the user.

11. The method of claim 10, wherein the eyeglass frame information further comprises at least one eyeglass frame measurement for the at least one eyeglass frame, and wherein the user information further comprises user head and facial measurements, and wherein the user device further correlates the at least one eyeglass frame measurement to the user head and facial measurements when presenting the at least one eyeglass frame image on the user image to the user.

12. The method of claim 9, wherein the eyeglass frame information comprises at least one eyeglass frame measurement for the at least one eyeglass frame, and wherein the user information comprises user head and facial measurements, and wherein the user device further correlates the at least one eyeglass frame measurement to the user head and facial measurements to present a fit of the at least one eyeglass frame on the user to the user.

13. The method of claim 9 further comprising:
receiving a purchase request for one of the at least one eyeglass frame; and
completing the purchase request with the merchant for the one of the at least one eyeglass frame.

14. The method of claim 13, wherein the purchase request is further completed with the merchant for a lens in the one of the at least one eyeglass frame matching the eyeglass prescription.

15. The method of claim 9 further comprising:
receiving a purchase request for one of the at least one eyeglass frame; and
completing the purchase request with the merchant for the one of the at least one eyeglass frame.

16. The method of claim 15, wherein the purchase request is further completed with the merchant for a lens in the one of the at least one eyeglass frame matching the eyeglass prescription.

17. A non-transitory computer-readable medium comprising instructions which, in response to execution by a computer system, cause the computer system to perform a method comprising:
accessing an eyeglass prescription for a user;
retrieving eyeglass frame information for at least one eyeglass frame offered for sale from a merchant;
communicating the eyeglass frame information to a user device of the user with the eyeglass prescription, wherein the user device presents the eyeglass frame information to the user with user information;
receiving a purchase request for one of the at least one eyeglass frame; and
completing the purchase request with the merchant for the one of the at least one eyeglass frame.

18. The non-transitory computer-readable medium of claim 17, wherein the eyeglass frame information comprises at least one eyeglass frame image of the at least one eyeglass frame, wherein the user information comprises a user image of the user, and wherein the user device presents the at least one eyeglass frame image on the user image to the user.

19. The non-transitory computer-readable medium of claim 18, wherein the eyeglass frame information further comprises at least one eyeglass frame measurement for the at least one eyeglass frame, and wherein the user information further comprises user head and facial measurements, and wherein the user device further correlates the at least one eyeglass frame measurement to the user head and facial measurements when presenting the at least one eyeglass frame image on the user image to the user.

20. The non-transitory computer-readable medium of claim 17, wherein the eyeglass frame information comprises at least one eyeglass frame measurement for the at least one eyeglass frame, and wherein the user information comprises user head and facial measurements, and wherein the user device further correlates the at least one eyeglass frame measurement to the user head and facial measurements to present a fit of the at least one eyeglass frame on the user to the user.
